(19) United States
(12) Patent Application Publication
(10) Pub. No.: US 2016/0067951 A1
(43) Pub. Date: Mar. 10, 2016

(54) Seep Resistant Masking Material

(71) Applicant: Snotco, LLC, Oshkosh, WI (US)

(72) Inventor: David J. Gruenwald, Menasha, WI (US)

(21) Appl. No.: 14/940,374

(22) Filed: Nov. 13, 2015

Related U.S. Application Data
(63) Continuation-in-part of application No. 14/449,224, filed on Aug. 1, 2014.
Application No. 14/449,224 is a division of application No. 13/834,151, filed on Mar. 15, 2013, now Pat. No. 8,852,729.

(51) Int. Cl. B32B 37/12; B32B 1/00; B32B 7/14; C09J 7/02; B32B 37/20; B32B 41/00; B05B 15/04; B05D 7/00; B29C 65/00; B32B 38/00

(52) U.S. Cl. CPC B32B 37/1292; B29C 66/45; B32B 1/00; B32B 7/14; B32B 38/0004; B32B 37/203; B32B 41/00; B05B 15/0456; B05D 7/548; B29C 66/73187; C09J 7/02; B29L 2007/007

(57) ABSTRACT

A masking material and method of forming a masking tape that includes a substrate and an adhesive layer disposed on the substrate. Methods of manufacturing the masking material include features associated with forming a masking material having an adhesive layer that is preferably thicker than the substrate and includes features associated with providing an indicia associated with forming discrete rolls of the masking material with the desired degree of uniformity of an edge located adhesive. The method can also include substrate moisture, coating, and/or surface energy control or manipulation to achieve the desired adhesion between the adhesive and substrate associated with the masking material.

### CROSS REFERENCE TO RELATED APPLICATIONS

This application is a continuation-in-part and claims priority to pending U.S. patent application Ser. No. 14/449,224 filed on Aug. 1, 2014 titled “Seep Resistant Masking Material” and which is a divisional patent application that claims priority to U.S. Pat. No. 8,852,729 which issued on Oct. 7, 2014 from U.S. patent application Ser. No. 13/834,151 filed on Mar. 15, 2013 titled “Seep Resistant Masking Material” and the disclosures of which are incorporated herein.

### FIELD OF THE INVENTION

The present invention relates to adhesive masking materials, such as masking tape and more particularly, to a masking material that can be applied and removed from an underlying surface without damaging the surface, without leaving adhesive residue on the surface, and in a manner that prevents seepage of liquids between the masking material and the surface to which it is applied. The present invention further relates to methods of producing such a masking tape.

### BACKGROUND OF THE INVENTION

Adhesive tapes are typically comprised of a flexible substrate, such as paper, plastic, or cloth that has a layer of adhesive material applied to at least one side of the substrate. The adhesive layer commonly covers the entire surface of one side of the substrate or can be disposed along only one longitudinal edge thereof. Such devices are commonly referred to as masking tapes suitable for protecting or masking respective portions of a surface to which liquids, such as paint or stains, is applied wherein it is desired to generate a clean or crisp edge between the respective portions associated with the masking material.

Such masking tapes commonly include an adhesive that is applied as a generally very thin uniform layer across one or both of the faces of the substrate. Some manufacturers also provide masking materials wherein a respective edge of the masking material includes an adhesive that is applied to one side of the substrate and a liquid resistant material or plastic strip that is applied to the other side of the substrate to prevent contact of the liquid with the adhesive supporting substrate in an effort to improve degradation resistance of the substrate material when subjected to wet liquids. U.S. Pat. Nos. 1,726,744; 1,779,588; 2,171,544; 2,510,120 each suggest masking materials wherein relatively thin layers of adhesive are disposed along at least an edge portion of a strip of flexible substrate, U.S. Pat. No. 3,032,181 suggests a narrow band of adhesive on one or more edges of the tape and a corresponding coating on the back side of the tape to prevent adhesion and facilitate release of the adhesive from adjacent layers of the substrate when the masking material is provided as a roll.

U.S. Pat. No. 6,828,008 suggests placement of an absorbent layer on an edge of the substrate to at least substantially prevent liquids from being absorbed into the substrate and to retard the curing of liquids that may be applied to masking material. U.S. Patent Application Publication No. 2008/0318038 A1 teaches a masking material having a strip of liquid repellant material on a side of the substrate opposite the adhesive intended to prevent liquid material from adhering to the masking material.

Many of the masking materials associated with the aforementioned patent publications have been promoted in the marketplace as having edge sealing ability or edge blocking technology intended to prevent seepage of the liquid materials to that portion of the application surface that underlies the masking material and to maintain the integrity of the masking material to facilitate efficient removal of the same after the respective application process. Each of the disclosures referenced above attempt to resolve the long existing problem of providing a masking material that can withstand the application of liquid materials to the edge of the masking material and to do so in a manner that attempts to prevent seepage of the liquid materials to the portion of the application surface disposed generally behind the masking material. Those familiar with such products, and applicants testing associated with the present invention, clearly demonstrate that the currently available masking products perform in a manner that results in a less than desirable finished product.

The effectiveness of such masking products to prevent seepage is largely dependent on the roughness of the surface intended to be masked and when the surface is not smooth to even a small extent, seepage occurs and a clean sharp edge is not obtained. The root cause of such seepage is capillary action, or capillarity, which is the ability of a liquid to flow into very narrow spaces without the assistance of, and in opposition to external forces like gravity. The effect can best be seen in the drawing up of liquids between the hairs of a paint-brush, in a thin tube such as those used for biological or chemical testing, in porous materials such as paper, in some non-porous materials such as liquefied carbon fiber, or in a cell. Such capillary action occurs because of inter-molecular attractive forces between the liquid and solid surrounding surfaces. If a leakage path is sufficiently small, then the combination of surface tension, which is caused by cohesion within the liquid, and adhesive forces between the liquid and container act to force the liquid into the crevice or gap. Such capillary action is inadequately considered in many masking materials where small voids can be formed between the masking material and the treatment surface.

Although many of the masking materials referenced above can exhibit suitable seepage results when applied on truly planar surfaces, many if not all surfaces associated with painting activities are rarely truly planar. Particularly, the proliferation of textured wall and ceiling surfaces has proven such masking materials to have only very limited ability to adequately mask the respective portions of surfaces or adjacent surfaces for painting applications. The shortcomings of such products to adequately mask somewhat rough surfaces, such as sand textured, knock-down, orange peel, stucco or other cosmetic surface treatments is readily apparent to most users who have attempted to generate a line of demarcation between alternate liquid materials or colors applied to such surfaces.

While many of the companies that produce masking materials constructed in accordance with the disclosures associated with the patent documents cited herein advertise that their technology prevents paint from seeping under the edge of the tape, such assertions have shown only very limited authenticity with respect to surfaces that are not clean and very smooth, such as those encountered in most structures where the wall surfaces are “sand” or “textured” to some or even any extent. As demonstrated below with respect to the description provided with respect to FIG. 9, such assertions are frequently unsuited to replication to real life applications.

Another shortcoming associated with many commercially available masking materials is associated with the ability to remove the masking material, and preferably all or at least a majority, of the adhesive associated therewith. That is, evaporation or incorporation of the liquid constituents with the treatment materials during curing of the same frequently negatively affects the user's ability to remove the masking material as a preferably continuous strip and in a manner wherein the adhesive remains adhered to the substrate material during the removal process. Commonly, curing of paints or the like weakens the substrate and/or negatively effects the adhesion between the substrate and the adhesive such that the substrate tears or the adhesive separates from the substrate during the removal process. Such occurrences increase cleanup efforts associated with removal of the masking material from the underlying application site.

The relative degree of degradation of the substrate and/or the separation of the adhesive from the substrate can dramatically detrimentally impact the user's experience associated with removal of the masking material. Accordingly, there is a need for a masking material whose substrate has sufficient integrity to withstand the wetting and drying sequence associated with the curing process of various application materials. There is a further need for a masking material whose substrate and adhesive material exhibit adhesion and/or cohesion properties or characteristics that are greater than the adhesion characteristics associated with the interface between the adhesive material and the underlying treatment surface during each of the application, treatment, and removal processes.

Still another concern associated with forming masking materials relates to manufacturing processes associated with forming discrete rolls of the masking materials from a bulk roll or spool. Masking material manufacturing processes commonly include the deposition of adhesive relative to a substrate and the subsequent segregation of the master spool into discretely useable consumer product rolls. Those products that include a uniform adhesive layer across one or both sides of the substrate can be conveniently cut longitudinally into discrete rolls as the material between respective cutting blades has a uniform cross section. However, ignoring the placement of the substrate material relative to the cutting tools can result in dissimilar product formation.

As elongated web or sheet material is frequently susceptible to lateral translation, commonly referred to as “walk” or “wonder” of the sheet material relative to the underlying system during longitudinal translation of the sheet material during subsequent manufacturing processes, attention must be given to the lateral position of the sheet material to generate the desired subsequent cutting thereof. Failure to properly attend to the lateral translation of the sheet material during the cutting or slitting operation can result in the undesirable generation of multiple products having dissimilar edge adhesive treatments. Accordingly, there is also a need for a masking material manufacturing system that can manipulate the lateral position of the sheet material to counteract the detrimental effects of material walk or wander in directions transverse to the processing direction.

Therefore, there is a need for a masking material that can withstand the rigors of being subjected to liquid materials, can be removed from an underlying treatment surface without degradation or separation of the respective portions of the masking material, can be manufactured in a uniform manner even when provided in a non-uniform cross section configuration, and can tolerate deformation of the masking material to match the contour of the underlying treatment surface to reduce or eliminate seepage behind the masking material while facilitating efficient removal of the masking material.

### SUMMARY OF THE INVENTION

The present invention discloses a masking material that solves one or more of the aforementioned drawbacks. One aspect of the invention discloses a masking tape and method of forming a masking tape that includes a substrate and an adhesive layer secured to the substrate. The adhesive layer is preferably at least 0.003 inches thick and formed of a material that has a modulus of elasticity with a proportionate amount of tack that allows the adhesive layer to elongate and deform to match the contour of discontinuities associated with a surface to which the masking material is applied. Preferably, the adhesive layer is formed in two narrow rows that are aligned with the longitudinal edges of the substrate and which increase the unit pressure on the adhesive when applying the tape to the masked surface by reducing the effective area of adhesive in contact with the masked surface thus preventing seepage of liquid materials between the masking tape and the surface to which it is applied.

Another aspect of the invention that is usable with one or more features of the above aspect discloses a masking tape that includes a substrate and an adhesive. The substrate includes a top surface and a bottom surface and two edges that are defined by a thickness of the substrate and that separate the top and the bottom surfaces. The adhesive is disposed on the bottom surface along at least one edge of the substrate. The adhesive extends in an outward direction from the bottom surface of the substrate to define a thickness of the adhesive that is greater than 0.003 inches and is elastically deformable when coming in contact with a surface such as a painted wall to at least more than 1.25 times an at-rest thickness of the adhesive.

Another aspect of the invention that is usable with one of more of the features or aspects above discloses a tape assembly that includes a substrate layer and an adhesive layer. The substrate layer has opposing faces and opposing edges that each extend a longitudinal length of the substrate such that the opposing faces are oriented transverse to a thickness of the substrate layer defined by a length of the opposing edges. The adhesive layer is secured to at least one of the faces of the substrate layer such that an edge of the adhesive layer is aligned with least one of the opposite edges of the substrate layer and the adhesive layer has a thickness as defined by a dimension that is aligned with the thickness of the substrate layer and that is at least 1.5 times greater than the thickness of the substrate layer.

Another aspect of the invention that is usable with one or more of the above aspects or features discloses a method of forming a masking tape that includes applying multiple rows of adhesive to a backer material. The backer material and the multiple rows of adhesive are formed into an elongated roll by rolling the backer material onto itself so that the multiple rows of adhesive are captured between adjacent layers of backer material. The elongate roll is partitioned into discrete rolls that each have a maximum diameter that is the same as the elongated roll by cutting the elongate roll at locations that divide at least one of the multiple rows of adhesive into a first portion that is associated with an end of a first discrete roll, and a second portion that is associated with an end of a second discrete roll.

A further aspect of the invention that includes one or more features usable with the above aspects discloses a method of forming masking tape that includes applying multiple rows of adhesive to a backer material and forming an elongated roll by rolling the backer material onto itself so that the multiple rows of adhesive are captured between adjacent layers of backer material. An indicia is provided that provides an indication of a lateral location of at least one of the multiple rolls of adhesive relative to the backer material. The indicia is monitored and the elongate roll partitioned into discrete rolls by cutting the elongate roll based on information associated with the indicia.

Another aspect of the invention that includes one or more features or aspects and useable with one or more of the above aspects discloses a method of forming a masking tape material. The method includes selecting an adhesive to be elastically deformable and to have a stiffness value that is insufficient to overcome a tack value associated with interaction of the selected adhesive with an intended application surface. A backer material is selected for supporting the selected adhesive. At least one side of the backer material is treated with a plastic material prior to placement of the selected adhesive relative thereto so as to generate the desired adhesion between the adhesive and the backer material.

Another aspect of the invention that includes one or more features or aspects and useable with one or more of the above aspects discloses a method of forming a masking material that includes providing a substrate material and treating at least one side of the substrate material with a plastic material. A surface energy of the plastic material is manipulated to achieve a desired adhesion of an adhesive disposed on the at least one side of the substrate material to the substrate material.

Other aspects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

The drawings illustrate the best mode presently contemplated for carrying out the invention.

FIG. 1 is a perspective end view of a masking material according to the present invention;

FIG. 2 is a front elevation view of a roll of the masking material shown in FIG. 1;

FIG. 3 is a top plan view of the masking material shown in FIG. 1 engaged with an exemplary treatment surface;

FIGS. 4A and 4B show a table that associates the thickness of the adhesive layer relative to a peak to peak surface roughness associated with the surface to be treated.

FIG. 5 is a plan view of an exemplary manufacturing process associated with producing the masking material shown in FIG. 1;

FIG. 6 is an elevation view of a splitting process associated of the masking material shown in FIG. 1 when produced with the exemplary manufacturing process shown in FIG. 4;

FIG. 7 is a schematic representation of a cutting or slitting assembly configured to generate a plurality of discrete rolls from a master roll or spool that includes a plurality of discrete rolls;

FIG. 8 is a graphical representation of a cutting and indexing assembling configured to maintain a portion each respective bead along a lateral edge of each discrete roll separated from a master roll shown in FIG. 7; and

FIG. 9 is an elevation view and shows the seepage resistant results achieved with the masking material shown in FIG. 1 as compared to various other self asserted seepage proof masking materials.

While masking devices or tapes and methods of forming and using the same are susceptible to various modifications and alternative forms, specific embodiments thereof have been shown by way of example in the drawings and are herein described in detail. It should be understood, however, that the description herein of specific embodiments and methods is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

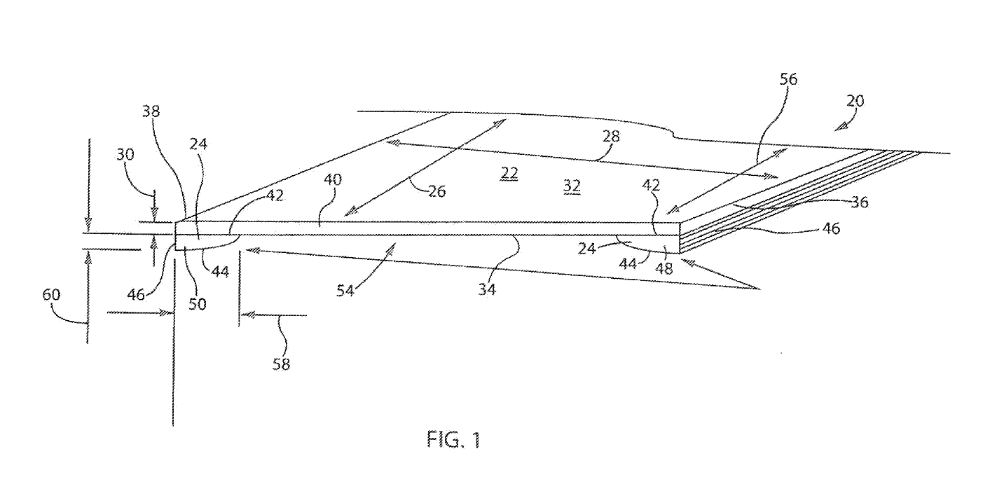

FIG. 1 shows an end perspective view of a masking tape or masking material 20 according the present invention. Masking material 20 includes a backer material or substrate 22 and an adhesive 24 disposed thereon. Substrate 22 is generally defined by a layer having a length 26, a width 28, and a depth or thickness 30. Substrate 22 includes a first side or surface 32 and a second side or surface 34 whose shape is defined by length 26 and thickness 30 of substrate 22. Surfaces 32, 34 can generally be considered the opposite working surfaces of material 20 wherein one side is directed to face a treatment surface and the other side faces atmosphere. Substrate 22 includes a first edge 36 and a second edge 38, or opposite opposing lateral edges or sides, associated with length 26 and thickness 30. Substrate 22 includes a terminal end or edge 40 that is defined by width 28 and thickness 30. Preferably, substrate 22 is formed of a flexible material such as plastic, cloth or paper and such that thickness 30 has an approximate dimension of between 0.001 inches and 0.005 inches of total thickness.

As disclosed further at various locations of the present application, it is appreciated that substrate 22 could be provided in various shapes and forms and be formed of various materials, including cloth, plastic, or paper, as mentioned above, to achieve one or more of the various objectives disclosed herein. Some such objectives being the selective manipulation, such as cutting or tearing of the tape material when and in a desired manner and convenient removal of the tape material from underlying surfaces. It is appreciated that substrate 22 can be configured to provide a tear or cut resistance that is greater in one direction as compared to another direction. Said in another way, the tearing properties of substrate 22 can be manipulated during the manufacturing process such that substrate 22 tears easily in one direction, such as a lateral or cross direction (CD), and has greater tear resistance in another direction, such as a longitudinal or machine direction (MD).

One suitable example of a material having such alternate direction alternate tear performances is referred to as extensible or semi-extensible kraft paper. It is appreciated that the tear performance or resistance could be manipulated in various manners to achieve tape products with different tear performances. Preferably, the cross direction tear performance of masking material 20 is weaker than the longitudinal direction tear performance of material 20 such that material 20 can be conveniently manually torn in the cross direction but has a higher tear resistance in the longitudinal direction such that material 20 can be removed from an underlying surface without separation of the masking material 20 or substrate 22 in the longitudinal direction.

Adhesive 24 is disposed on at least one of side surfaces 32, 34 of substrate 22 proximate at least one of edges 36, 38. Preferably, adhesive 24 defines alternate beads wherein a respective bead is positioned proximate each of edges 36, 38 as explained further below. Adhesive 24 includes a first side or surface 42 that engages surface 34 of substrate 22 and another surface 44 that is generally opposite surface 42. Adhesive 24 includes an edge 46 that is generally aligned with a respective edge 36, 38 of substrate 22.

As shown in FIG. 1, masking material 20 is provided with a first row or bead 48 and a second row or bead 50 of adhesive 24 wherein each bead 48, 50 extends along length 26 of substrate 22. Preferably, material 20 includes a bead 48, 50 that is positioned proximate each respective edge 36, 38 of substrate 22 such that a gap 54 is formed between first bead 48 and second bead 50 of adhesive 24. Although two rows or beads 48, 50 of adhesive 24 are shown engaged with surface 34 of substrate 22, it is appreciated that other numbers of rows of beads can be provided and disposed on surface 34 of substrate 22 or disposed in gap 54. It is further appreciated that the entirety of surface 34 of substrate 22 could be covered with adhesive 24 but that doing so would result in an increased cost without substantial performance improvement for most applications. Preferably, depending on the dimension of width 28 of substrate, gap 54 can include one or more rows or interstitial amounts of adhesive 24 along length 26 to limit deformation of substrate 22 during use of masking material 20 and to facilitate a more uniform shape of masking material 20 when provided in a roll configuration.

Each bead 48, 50 of adhesive 24 is defined by a length 56, a width 58 and a depth or thickness 60 associated therewith. As used herein, it should be appreciated that length 56 of respective beads 48, 50 are oriented in the same direction as length 26 of substrate 22, width 58 of respective beads 48, 50 are oriented in the same direction as width 28 of substrate 22, and thickness 60 of perspective beads 48, 50 are oriented in the same direction as thickness 30 associated with substrate 22. In a preferred embodiment, each bead 48, 50 of adhesive 24 has a width 58 that can be between 0.040 and about 0.200 inches and a respective thickness 60 that is preferably greater than about 0.003 inches and is more preferably between about 0.010 inches and about 0.100 inches. As used herein the term “about” is intended to incorporate those values within +/−0.007 of the lowermost adhesive thickness parameter and within +/−0.050 of the uppermost adhesive thickness parameter or parameters approximately or nearly, and in the context of a numerical value or range set forth, ±10% of the numerical value or range recited or claimed. Preferably, width 58 of adhesive 24 is greater than the depth or thickness 60 of adhesive 24. Preferably, the dimension of width 58 and thickness 60 are related by a ratio of approximately 3:1. In a preferred embodiment of the present invention, adhesive 24 is provided in one or more beads that have a thickness 60 in the range of approximately 0.020-0.040 inches and a width 58 that can be any dimension but is preferably 0.060-0.120 inches. It is however appreciated that other ratios of the geometry of adhesive 24 are envisioned to satisfy the requirements related to the adhesion and tack of masking material 20 relative to both itself as well as treatment surfaces as explained further below.

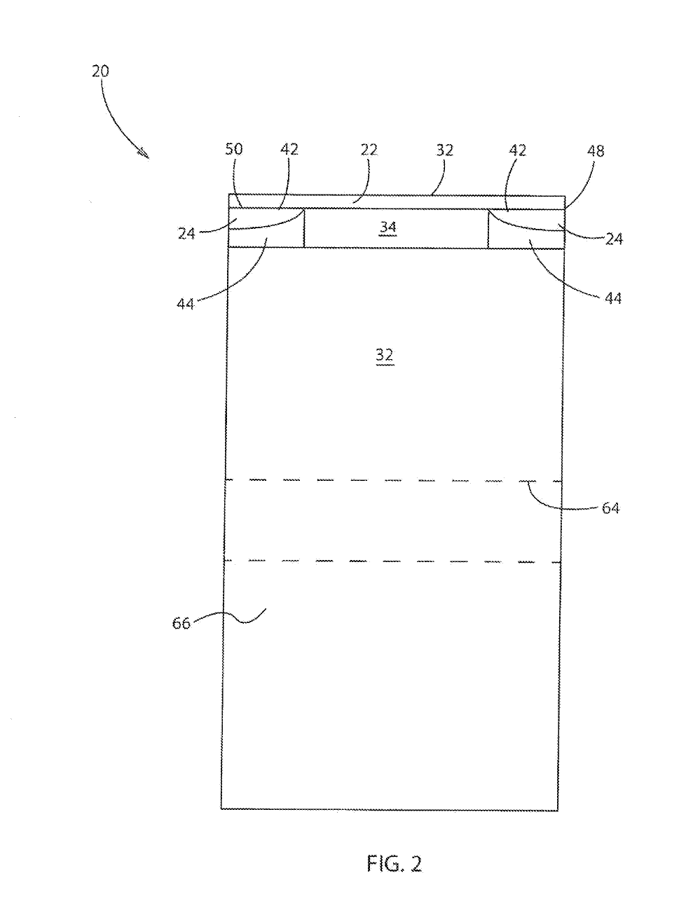

FIG. 2 shows a side elevation view of masking material 20 in a roll configuration as indicated by a core 64 associated with roll 66 of masking material 20. As shown therein, beads 48, 50 of adhesive 24 are disposed between adjacent layers of substrate 22 such that surface 42 of beads 48, 50 is disposed on surface 34 of substrate 22 and surface 44 removably cooperates with surface 32 of substrate 22 associated with an adjacent layer of the respective roll 66. Masking material 20 is constructed to be dispensed from roll 66 by peeling or unrolling of substrate 22 and respective beads 48, 50 of adhesive 24 from underlying layers of substrate 22. As explained further below, surface 32 of substrate 22 can be treated to prevent adhesion of adhesive 24 therewith but to maintain sufficient interaction to maintain the rolled orientation of material 20. It is further appreciated that material 20 could be provided in sheet or strip form rather than roll form although most users are fairly familiar with the roll type configuration of such masking materials.

Adhesive 24 associated with beads 48, 50 of masking material 20 is preferably selected from the group that includes at least polyurethane gel adhesives, silicone gel adhesives, and acrylic gel adhesives although it is appreciated that other types of adhesives may be formed and which exhibit the attributes discussed below. Preferably, substrate 22 and adhesive 24 are selected to satisfy various parameters associated with the usage of masking material 20 such as preventing a liquid such as paint from contacting a surface that has irregularities or texture and is located behind or covered by masking material 20. Surface 32 of substrate 22 may be treated to facilitate a convenient release of adhesive 24 therefrom, such as silicone coating, to enable the respective layers of mask material 20 to be rolled onto itself and easily unrolled from adjacent layers when provided in a rolled configuration such as roll 66. Surface 34 of substrate 22 may be prepared for the desired inseparable adhesion of adhesive 24 to surface 34 of substrate 22. Preferably, adhesive 24 has an approximate shore hardness on the 00 scale of 20.

A number of considerations must be addressed to achieve a desired respective adhesion of adhesive 24 to surface 34 of substrate 22, between adhesive 24 and surface 32 of substrate 22 when in a roll configuration prior to use, and between adhesive 24 and a treatment surface during placement and removal of masking material 20 to achieve the desired separation and secure connection between adhesive 24 and substrate 22 to facilitate the desired use of thereof. As a first consideration the moisture content of substrate 22 must be sufficiently controlled or reduced to facilitate the desired adhesion of adhesive 24 and surface 34. Preferably, when substrate 22 includes a wood or cellulose type material, the substrate is wrapped or contained in an enclosed or heated low moisture environment to mitigate the absorption of moisture into the cellulose material of the substrate 22 until adhesive is applied thereto.

Prior to coating or application of adhesive 24 to substrate 22, a thin film of plastic; such as polyethylene (PE), polypropylene (PP), polyethylene terephthalate (PET), etc.; is applied to substrate 22. The plastic film is laminated, extruded, etc. to the cellulose material associated with the formation of substrate 22 and provides a moisture barrier and consistent surface associated with the adhesion of adhesive 24 to substrate 22. At least surface 34 of the plastic coated substrate 22 is preferably subjected to a corona treatment, plasma treatment, chemical etch, etc. to increase the surface energy associated with surface 34 to enhance the chemical bonding or adhesion of adhesive 24 thereto. Such processing provides the desired adhesion between surface 34 of substrate 22 and adhesive 24 and a lower adhesion between surface 32 and adhesive 24 when masking material 20 is provided in roll form.

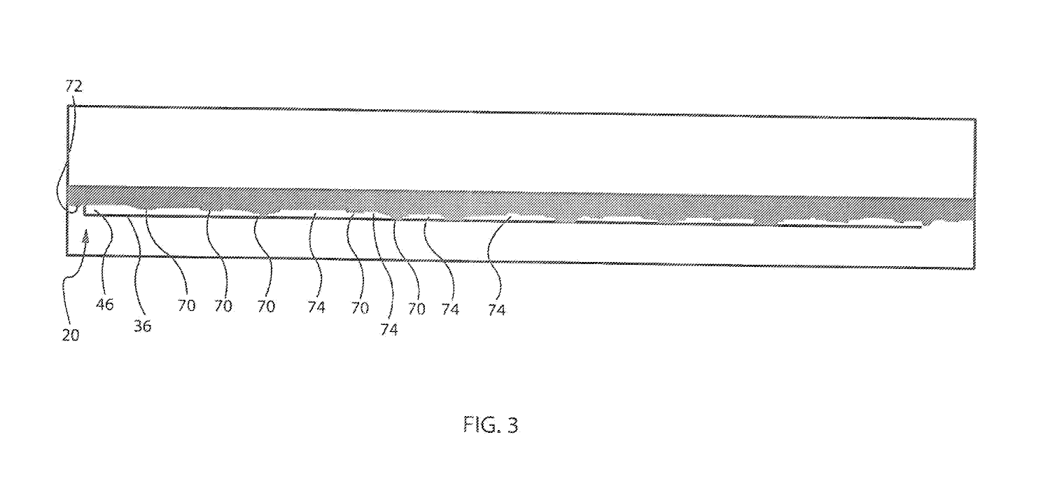

Referring to FIG. 3, adhesive 24 preferably exhibits viscoelastic properties as explained further below, that allow adhesive 24 to conform to uneven surfaces associated with a treatment surface 72 through the action of cold flowing to achieve the herein described sealing characteristics with a respective application or treatment surface. FIG. 3 is a top plan view of a portion of masking material 20 engaged with portion of a treatment surface 72 that includes a number of peaks 70 that are separated by adjacent valleys 74 associated with treatment surface 72. Adhesive 24 conforms to the shape of surface 72 to fill voids, cavities, or valleys 74 between adjacent peaks 70 of a treatment surface 72 that underlie masking material 20 to form an effective barrier to leakage or seepage, including seepage caused by capillary action, between masking material 20 and a treatment surface 72 to which the masking material 20 is applied. It should be appreciated that the view shown in FIG. 3 is indicative of a side plan view of a respective edge 36 of substrate 22 and a corresponding edge 46 of a respective bead 48, 50 of adhesive 24. Preferably, edges 36, 46 are coplanar. The viscoelastic properties of adhesive 24 allows adhesive 24 to comply to the exact contour of treatment surface 72 and in a manner wherein adhesive 24 maintains secure interaction with substrate 22 for subsequent removal of masking material 20 from treatment surface 72 but can withstand the rigors associated with painting activities that overlap material 20. Adhesive 24 preferably exhibits a unique combination of physical properties to eliminate seepage under most conditions and still be removable from surfaces of drastically differing surface energy as are found in normal conditions and that is uncommon to most commercially available adhesives.

It is appreciated that masking material 20 may be configured to cooperate with various different treatment materials that have discrete respective surface roughness profiles. That is, where “smoother” but none the less non-planar surfaces are to be treated, adhesive 24 can be provided with beads having lower thicknesses 60 as compared to surfaces having more abrupt or aggressive surface discontinuities, such as stucco or knock-down texture treatments. Providing roll 66 in various bead configurations allows the user to select the masking product having a thickness 60 of adhesive 24 suitable for a given application or intended use. Such a consideration also allows more judicious and economical use of only necessary quantities of adhesive 24 for particular tasks.

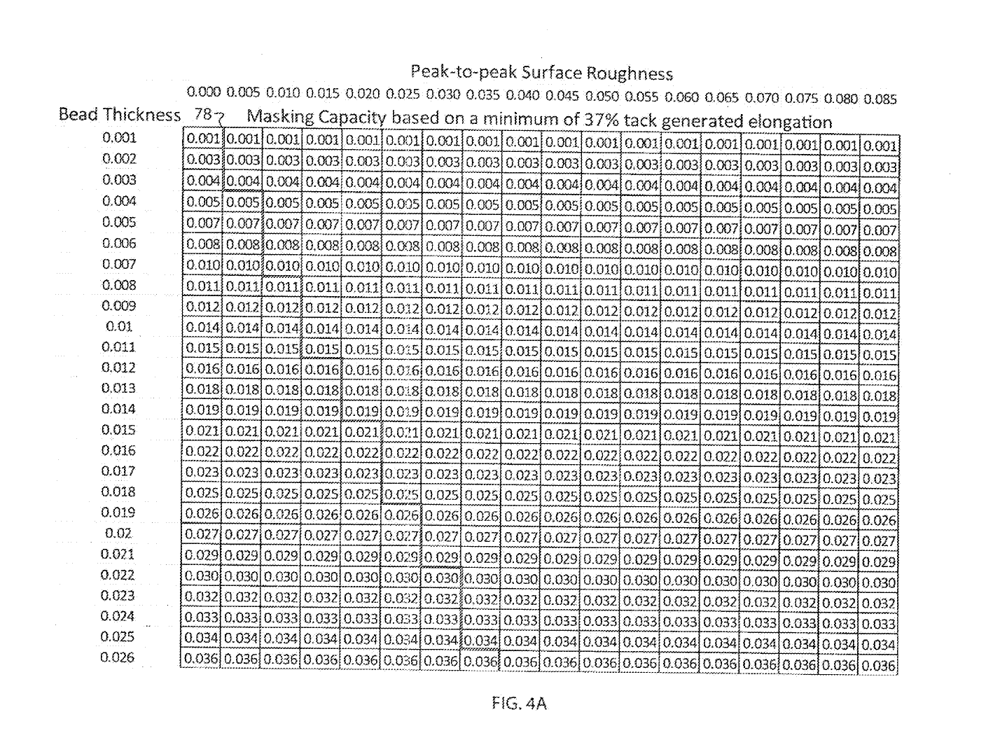

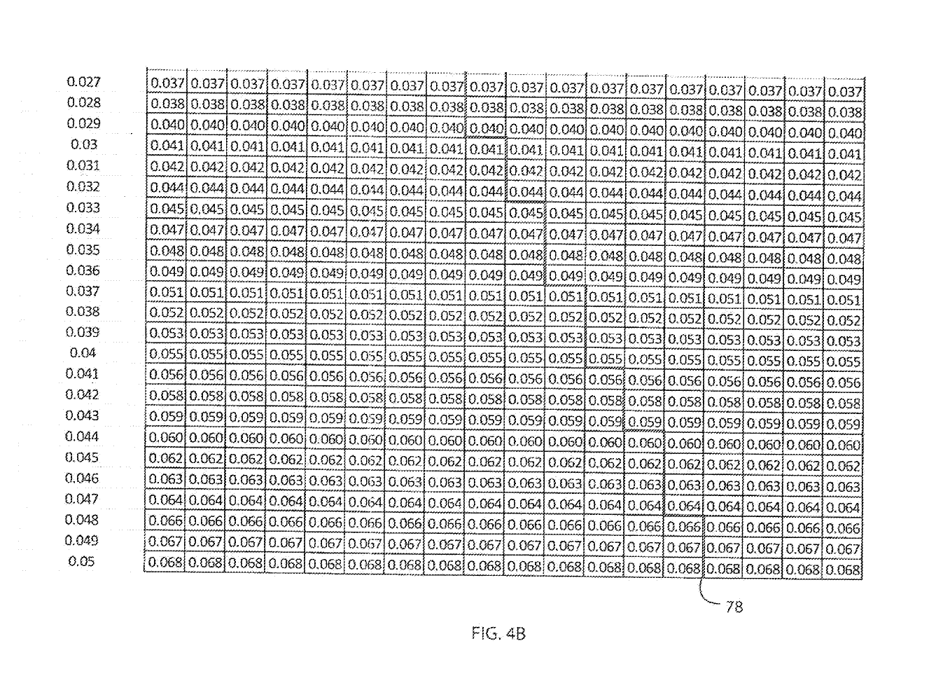

Regardless of the application or intended use of masking material 20, adhesive 24 is preferably provided so as to satisfy the parameters set forth in the following table and the information provided in FIGS. 4A and 4B with respect to the tack between surface 34 of substrate 22 and adhesive 24, the separable tack between surface 32 of substrate 22 and adhesive 24, and the separable tack between treatment surface 72 and surface 44 of adhesive 24:

TABLE 1

| | | Minimum | | Maximum |
|---|---|---|---|---|
| Masking Adhesive Specification | Units | Value | Ideal | Value |
| 8 mm depth ½″ diameter probe, 50 mm/secpenetration rate load | Grams | 1000 | 2100 | 3200 |
| Tack caused elongation on MSE surface (Primer) (% of initial thickness) | % | 30 | 52.5 | 75 |
| Tack caused elongation on LSE surface (Lexan) (% of initial thickness) | % | 25 | 37.5 | 50 |
| Tack caused elongation (%) on HSE surface (Stainless Steel) (% of initial thickness) | % | 40 | 70 | 100 |
| Tack ratio on MSE surface (Primer) (tack in psi divided by total elongation %) | psi (lbs/sq.in.) | 9.5 | 24.75 | 40 |
| Tack ratio on LSE surface (Lexan) (tack in psi divided by total elongation %) | psi (lbs/sq.in.) | 9.5 | 24.75 | 40 |
| Tack ratio on HSE surface (Stainless Steel) (tack in psi divided by total elongation %) | psi (lbs/sq.in.) | 9 | 24.5 | 40 |
| Thickness | inch | 0.01 | 0.045 | 0.08 |

FIGS. 4A and 4B include further information indicative of achieving the desired tack and/or adhesion interaction explained above and shows a line of demarcation 78 wherein the thickness 60 of adhesive 24 can be manipulated to provide the desired full contact engagement with a treatment surface as a function of the peak-to-peak surface roughness associated with various treatment surfaces as a function of the bead thickness 60 associated with maintaining continuous contact of adhesive 24 with the underlying treatment surface thereby reducing or preventing seepage of liquid materials to those areas that underlie masking material 20.

Preferably, adhesive 24 is a gel type material or a material that is sufficiently pliable so as to conform to the discontinuities associated with treatment surface 72 without separating from substrate 22 and is yet conveniently wholly removable from the treatment surface via user manipulation of substrate 22. Preferably, substrate 22 and adhesive 24 cooperate with one another in a manner that resists cohesive failure of adhesive 24 relative to substrate 22 during removal or manipulation of masking material 20 during use—aside from tearing or cutting terminal ends or edge 40 of a respective length of material 20. As used herein, the tack of adhesive 24 is the immediate strength of the bond of adhesive 24 with a surface and adhesion is a longer term strength of a respective bond. That is, tack forms immediately or in seconds whereas adhesion bond strengths increase over time. Adhesive 24 is preferably selected to provide a desired tack value with a preferably low adhesion value. During testing, polyurethane gels displayed desired tack parameters with acceptable adhesion values even after extended periods of contact of adhesive 24 with treatment surfaces 72. Preferably, adhesive 24 is selected to maintain complete contact with treatment surface 72 without returning to an at rest shape of the adhesive and does so in a manner that maintains a secure interaction of the adhesive 24 with surface 34 of substrate 22 for subsequent removal of masking material 20 without detriment to surface 72 during the removal process, such as the undesired removal of paint that may have been previously applied to treatment surface 72.

During application of material 20, material 20 can be applied with finger or palm pressure such that adhesive 24 populates valleys 74 and contacts peaks 70 to define a continuous interaction with surface 72. Although adhesive 24 wants to return to an original or at rest shape, adhesive 24 is selected to have a stiffness or modulus (ratio of stress to strain) that is insufficient to overcome the tack associated with the interaction of adhesive 24 with surface 72 thereby maintaining contact engagement with the entirety of demarcation associated with edge 36, 46 and surface 72. Gap 54 (FIG. 1) associated with masking material 20 allows expedient removal of masking material 20 from the underlying surface with a fraction of the total force that would be required to effectuate the same removal were surface 34 fully occupied by adhesive 24. Understandably, allowing adhesive 24 to extend from edge 36 to edge 38 of substrate 22 may be desirable in other applications but for applications intended to generate only a single line of demarcation between surface treatments, only one of edges 36, 38 need include a bead 48, 50 of adhesive 24. It is further appreciated that providing both edges with beads 48, 50 of adhesive 24 can prove beneficial to forming of a uniform roll 66.

Various efforts undertaken to assess the merits of various alternative adhesives included consideration of the contact tack generate elongation of various adhesives when subjected to various probes having different degrees of surface porosity. The testing process included subjecting various adhesives to a primer coated probe, a brushed stainless steel probe, and a polycarbonate probe. Once placed in contact with the respective adhesives, the probe was withdrawn and the elongation of the adhesive was assessed relative to an at rest configuration of the adhesive. This testing provided the assessment that adhesives that exhibit at least 25% contact tack generated elongation when associated with a polycarbonate material proved to have an effective elongation and tack association to achieve one or more of the objectives disclosed herein.

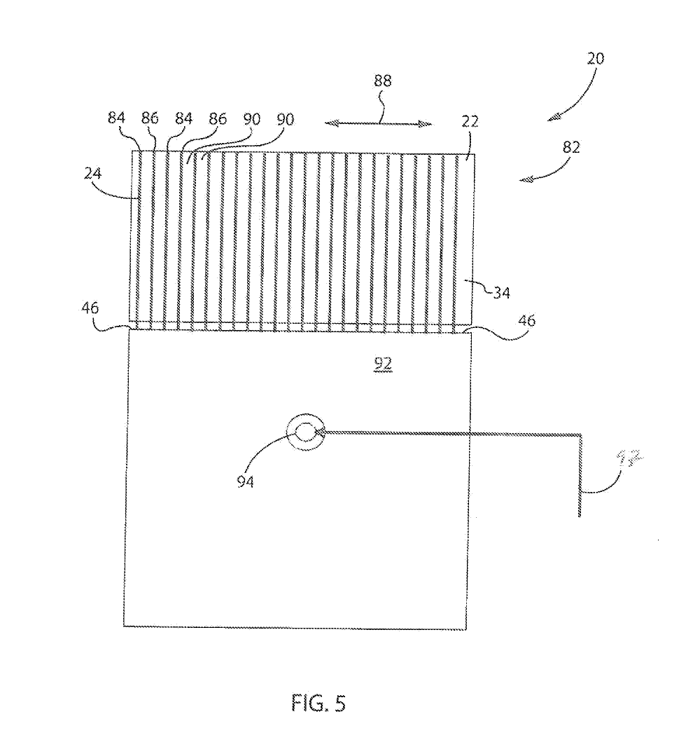

FIGS. 5-8 show schematic representations associated with generating one or more discrete rolls 66 of masking material 20 from a bulk or master spool or roll 82. Elongated bulk roll 82 of masking material 20 can be formed by disposing one or more elongated beads 84, 86 of adhesive 24 along a longitudinal length, indicated by arrow 88, of roll 82. Beads 84, 86 are supported by surface 34 of substrate 22 in spaced relation relative to adjacent beads such that one or more gaps 90 are formed between adjacent beads 84, 86 of adhesive 24. A die or other reservoir 92 includes an input 94 and a plurality of outputs 96 associated with communicating adhesive 24 from a bulk source 97 to surface 34 of substrate 22 in respective beads 84, 86. It is appreciated that source 97 can be configured to cooperate with a uniform adhesive material and/or configured to receive the constituent parts associated with forming adhesive 24.

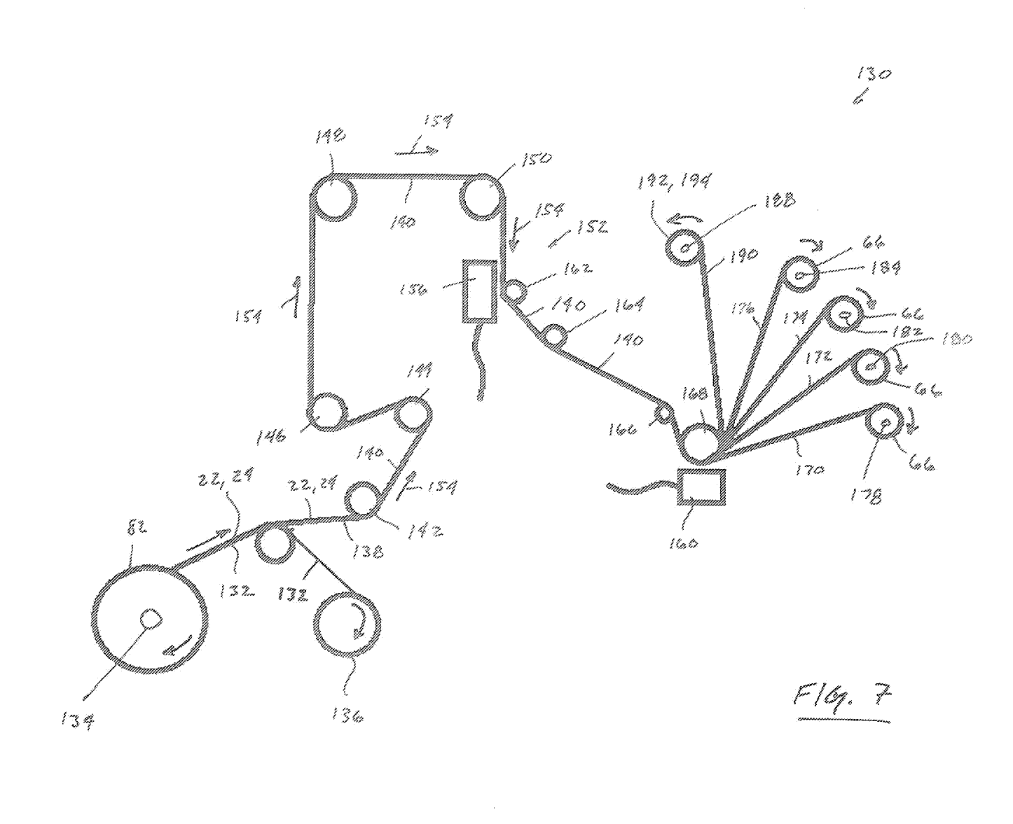

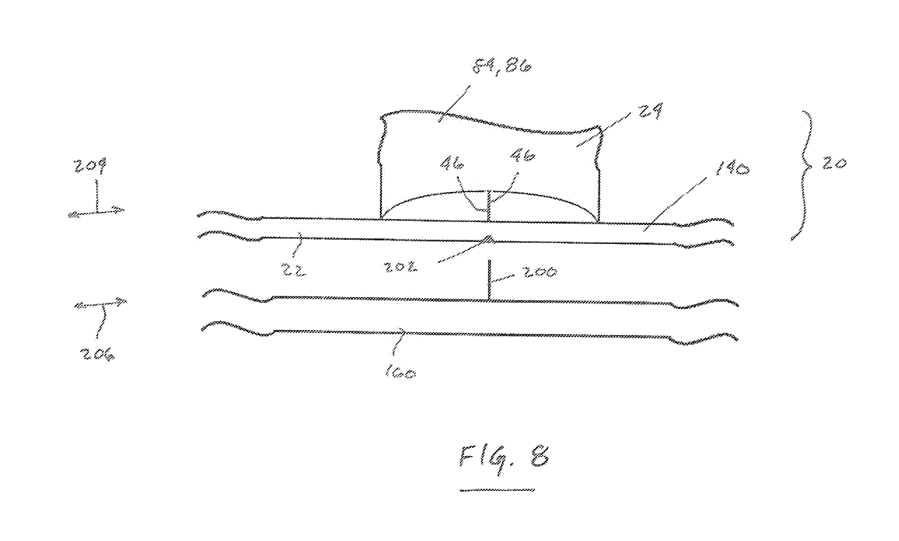

As disclosed further below with respect to FIGS. 7-8, it is further appreciated that one or more indicia can be provided that are associated with a respective location of one or more of beads 84, 86 to facilitate the desired separation of the discrete rolls 66 from spool or master roll 82. As also explained further below, it is also appreciated that a lateral edge associated with roll 82 can be utilized to laterally index the master roll 82 during a slitting or cutting operation associated with the formation of individual discrete rolls 66.

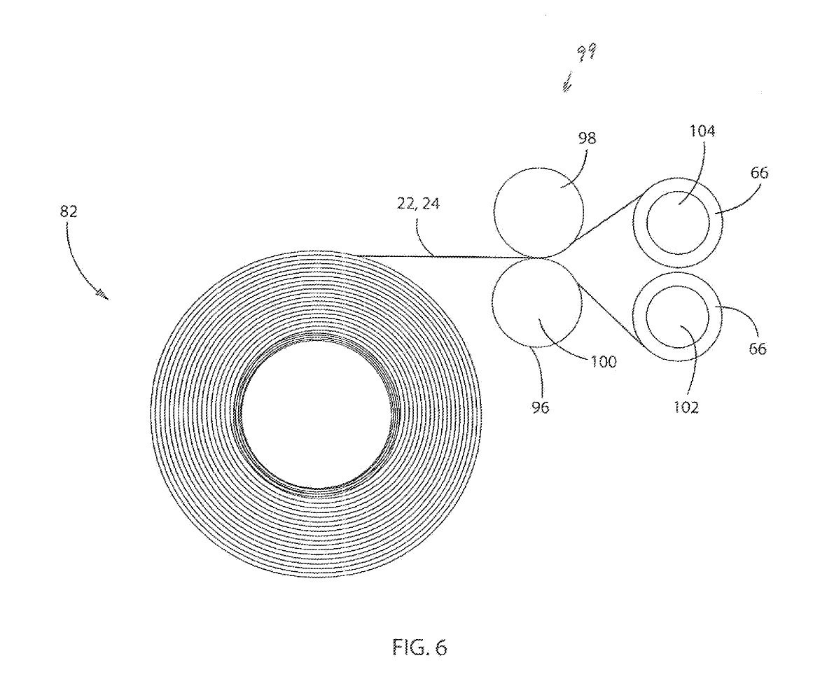

Referring to FIGS. 6-8, roll 82 can be subsequently cut or bifurcated into individual rolls 66 having a desired width via the passage of the respective layers of substrate 22 and associated rows or beads of adhesive 24 through a cutting, slitting, or splitting device 99 associated with cutting of roll 82. Preferably, splitting device 99 cooperates with masking material 20 passed between a first roller 98 and a second roller 100 so as to cut or otherwise split roll 82 at locations associated with each of beads 84, 86 so that a respective portion of each bead 84 is associated with a first roll 102 and a second roll 104 and a respective portion of each bead 86 is also associated with first roll 102 and second roll 104. Said in another way, each bead 84, 86 is split to form the respective bead 48, 50 associated with the opposite lateral edges of roll 66 of masking material 20. Operation of splitting device 99 ensures that each of the alternate edges 36, 38 associated with substrate 22 and edges 46 associated with respective beads 48, 50 are provided in a substantially coplanar configuration relative to the respective edges 36, 38 of each discrete roll 66 and are generally normal or transverse to surfaces 32, 34 of substrate 22.

FIGS. 7 and 8 relate to a more detailed explanation associated with a splitting assembly 130 that can be configured to generate a desired number of discrete rolls 66 of masking material from a master roll 82. It is appreciated that some manufacturing processes can be configured to accommodate splitting of master roll 82 shortly after placement and/or curing of beads 84, 86 whereas other manufacturing processes may be better suited to receive a previously manufactured master rolls 82 and subsequently separate the discrete rolls 66 therefrom. It is further appreciated that for some such processes, it can also be advantageous to include a liner 132 that is associated with the respective beads 84, 86 of adhesive 24 and which is preferably removed prior to spooling of discrete rolls 66. Understandably, such a liner 132 could remain between adjacent layers of rolls 66 although such a configuration would require slitting of the liner and subsequent removal of the liner during use of masking material 20 by a user.

Referring to FIG. 7, in one embodiment, master roll 82 is supported by a payoff roller 134 that is configured to deliver the sheet material 140 consisting of substrate 22 and adhesive 24, and liner 132 to splitting assembly 130. A liner spool 136 removes and collects liner 132 from the adhesive facing surface 138 of sheet material 140. One or more tensioning and/or guide wheels or rollers 142, 144, 146, 148, 150 facilitate communication of sheet material 140, in a feed direction, indicated by arrows 154, toward an indexing assembly 152. Indexing assembly 152 includes a detection device 156, such as an infrared radiation (IR) detection device, that is configured to monitor a lateral position of sheet material 140 as it progresses through splitting assembly 130. It is appreciated that detection device 156 could be configured to operate in other modalities such as optical, photo-optic, mechanical, or ultrasonic methodologies.

As explained further below with respect to FIG. 8, detection device 156 is configured to monitor the lateral placement of sheet material 140 relative to a cutting or slitting die or device 160 to maintain the desired separation associated with the formation of discrete roll 66, relative to the lateral placement of respective beads 84, 86. Said in another way, detection device 156 is configured to monitor the lateral position of sheet material 140 so as to achieve the desired alignment of one or more of beads 84, 86 with the respective cutting device associated with cutting the respective bead 84, 86 to achieve a generally uniform edge 46 associated with bead 48, 50 along the longitudinal length of each discrete roll 66. It is appreciated that for those application wherein the cutting operation is performed via a cutting roller or the like, or assemblies having more rigidly cooperating cutting or slitting knives, one or more of the plurality of guide or tension wheels or rollers 162, 164, 166, 168 can be manipulated to be moved in an axial direction to generate the desired presentation of sheet material 140 relative to slitting device 160. With respect to FIG. 7, it should be appreciated that such manipulations would be effectuated in directions normal to the plane associated with the view shown in FIG. 7. Once cut or slit, discrete portions 170, 172, 174, 176 of sheet material 140 are conveyed the respective product spools 178, 180, 182, 184 that are configured to spool each of discrete portions 170, 172, 174, 176 of sheet material 140 into discrete rolls 66 of masking material 20.

Splitting assembly 130 can also include an edge spool 188 that is configured to collect opposite lateral edge portions 190 of sheet material 140 after the cutting or splitting operation. It should be appreciated that opposite lateral edge portion 190 can most likely include only one respective lateral edge having a respective portion of a respective bead 84, 86 formed thereat. It should be appreciated that one or more rolls 192, 194 associated with the opposite edge portions 190 of sheet material 140 may be usable for certain applications, and or may be disposable as having only a single edge associated with substrate 22 as having a portion of adhesive 24 associated therewith. It should be appreciated that edge portions 190 are shown as a single line as the respective edge portions 190 align with one another in a plane normal to the view shown in FIG. 7.

Referring to FIG. 8, cutting or slitting device 160 includes one or more knives or blades 200 that are configured to cooperate with masking material 20 at respective locations associated with longitudinally cutting respective beads 84, 86 associated with adhesive 24 and the substrate 22 proximate thereto so as to form respective discrete rolls, 66, from sheet material 140. One or more indicia 202, are associated with substrate 22 and/or beads 84, 86, so as to laterally index the presentation of sheet material 140 relative to blade 200 so as to achieve a desired location associated with interaction of the blade with sheet material 140. It is appreciated that indicia 202 can be positioned during placement of beads 84, 86 relative to substrate 22, as a line or the like along the longitudinal length of sheet material 140, or other suitable methods such that indicia 202 being indicative of the lateral position of at least one of beads 84, 86. It is further appreciated that indicia 202 may be provided in other methodologies such as via cutting one of the lateral edges of sheet material 140 and subsequent utilization of the cut edge as the indicia associated with indexing sheet material 140 relative the lateral position of sheet material 140 for subsequent cutting operations.

Indexing assembly 152 is configured to manipulate the lateral position, indicated by arrows, 204, 206, of sheet material 140 and/or slitting device 160 to achieve the desired lateral orientation of blade(s) 200 relative to indicia 202. As alluded to above, it is appreciated that indexing assembly 152 can be configured to translate one or more of guide wheels or rollers 148, 150, 162, 164, 168, relative to a respective axis of rotation associated with the respective roller to achieve the desired lateral manipulation of sheet material 140 relative to slitting device 160. It is further appreciated that indexing system can be configured to manipulate a respective pressure associated with a respective edge of sheet material 140 to induce a desired “walk” or “wander” of the sheet material until the desired alignment of the respective indicia 202 and corresponding blade 200 is achieved. It should be appreciated that although FIG. 8 shows only one such blade 200, preferably, slitting device 160 includes a plurality of blades 200 that are uniformly spaced in lateral direction 206, and interact with sheet material 140 to achieve the desired width associated with rolls 66 intended to be produced.

Sheet material 140 can include one indicia 202 associated with establishing the lateral orientation of sheet material 140 relative to slitting device 160, and/or include a plurality of indicia indicative of the placement of beads 84, 86 of adhesive 24, to facilitate the desired association of blade 200 relative to respective beads 84, 86 such that each discrete roll 66 includes a bead 48, 50; or an approximate respective half of beads 84, 86; associated with the opposite lateral edges of each respective roll 66. Such a consideration accommodates deviations associated with the placement of beads 84, 86, relative to substrate 80 so as to form a roll of sheet material 140 that can be subsequently cut into multiple discrete rolls 66 of a desired with and with generally uniform edge adhesive treatments. Such considerations allow the slitting process to accommodate lateral translations termed the “wander” or “walk” of the substrate during application of the beads of adhesive during formation of master roll 82 and/or wander or walk of the sheet material 140 during the cutting operation and in a manner that facilitates generation of substantially uniform discrete rolls 66.

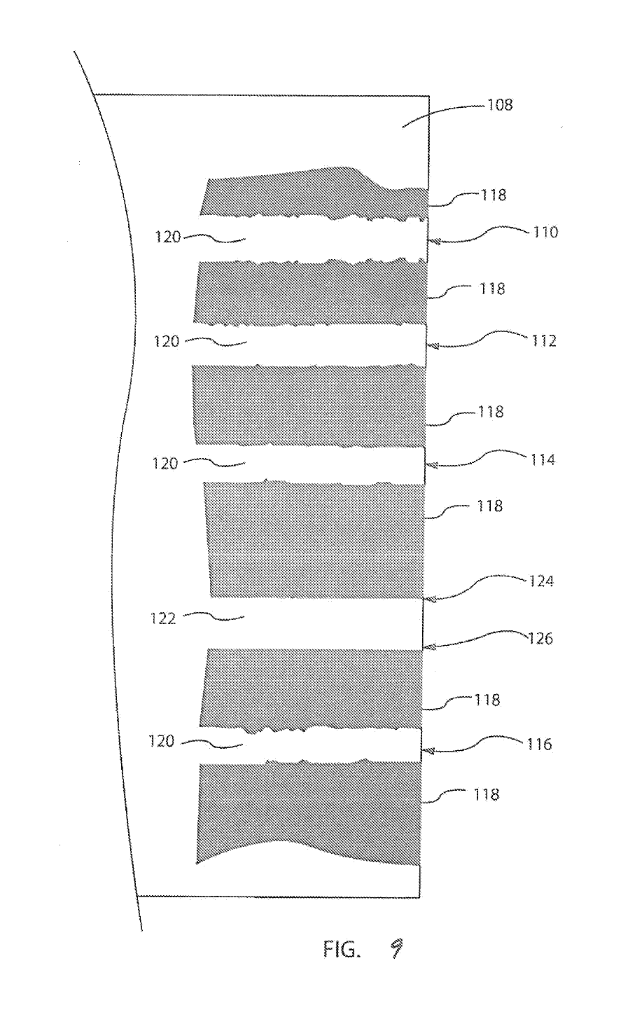

FIG. 9 shows a performance comparison of masking material 20 to various commercially available masking products that are advertised as having seepage resistance constructions and performance. As shown in FIG. 9, a treatment surface 108 having a substantially similar surface finish along the entirety thereof had various masking materials applied thereto and was subsequently painted such that the paint was applied Over each of the respective masking products. With respect to masking products 110, 112, 114, and 116, various degrees of seepage are clearly visible between painted portions 118 and the unpainted or masked portions 120 of surface 108 such that each of products 110, 112, 114, and 116 are associated with varying degrees of less than desirable demarcation between the masked and unmasked areas of sample surface 108. Many of the masking materials associated with products 110, 112, 114, and 116 have adhesive layers that extend the entirety of one surface of the substrate and have thicknesses that range generally from 0.0005 inches to 0.001 inches.

Comparatively, still referring to FIG. 9, masking material 20 was applied at area 122 of surface 108 such that a substantially crisp or linear area of demarcation 124, 126 are provided at the alternate lateral edges of associated with the interface between area 122 and adjacent painted portions 118. Adhesive 24 is provided at thicknesses that range for 0.003 inches and preferably about 0.010 inches to 0.050 inches or approximately 50 times the thickness of the adhesive thickness associated with prior masking materials. Preferably, the adhesive layer secured to at least one of the faces of the substrate layer such that an edge of the adhesive layer is aligned with at least one of the opposite edges of the substrate layer and the adhesive layer has a thickness as defined by a dimension that is aligned with the thickness of the substrate layer and a width that is defined by a dimension that is transverse to the direction of the width such that a ratio of the width to the thickness of the adhesive layer is between about 2:1 and about 15:1. For example, a 0.010 inch thick bead has a width that is preferably between about 0.020 inches and 0.150 inches wide. From a functioning standpoint, the bead should be as narrow as the slitting or cutting equipment can tolerate while maintaining continuous edge of the adhesive. Making the bead narrower than perhaps about 0.060 inches is expected to maintain functionality of the adhesive without detracting from the cutting process and would decreasing manufacturing costs. Preferably, the adhesive has a width and a thickness that is sufficient to maintain about 0.030 inch of sealed interaction with the treatment surface.

It should further be noted that removal of masking material 20 from area 122 left no residual indication of the presence of masking material 20 and did not blemish the surface 108 associated with removal of masking material 20. FIG. 7 clearly shows the advantages associated with utilization of masking material 20 for painting applications as compared to other various commercially available masking materials with respect to the seepage performance of masking material 20.

Therefore, masking material 20 provides a masking material that includes a substrate and an adhesive layer that is disposed on the substrate and is preferably greater than 0.003 inches thick and formed of a material that has a modulus of elasticity that allows the adhesive to conform to discontinuities associated with a surface to which the masking material is applied. Preferably, the adhesive is formed in multiple rows wherein at least one of the rows or beads is aligned with a lateral edge of the substrate to prevent seepage or capillary action of liquid between the masking material and the surface to which it is applied. Masking material 20 provides a temporary but secure interaction with the underlying surface to mitigate seepage in a manner that allows expedient removal of the entirety of the masking material from the underlying surface and in a manner that does not mare or otherwise deface the underlying surface or surface finishes or treatments.

What is claimed is:

1. A method of forming a masking tape comprising:
applying multiple rows of adhesive to a backer material;
forming an elongated roll by rolling the backer material onto itself so that the multiple rows of adhesive are captured between adjacent layers of backer material; and
providing an indicia that provides an of a lateral location of at least one of the multiple rolls of adhesive relative to the backer material; and
monitoring the indicia and partitioning the elongated roll into discrete rolls by cutting the elongated roll based on information associated with the indicia.

2. The method of claim 1 wherein applying multiple rows of adhesive is further defined as applying a bead of an adhesive selected from the group consisting of polyurethane gel adhesive, silicone gel adhesive, and acrylics to a surface of the backer material.

3. The method of claim 1 wherein the step of applying multiple rows of adhesive is further defined as applying a bead of adhesive at a width that is between about 0.040 inches and about 0.180 inches.

4. The method of claim 1 wherein providing the indicia is further defined as at least one of providing a line that extends along a longitudinal length of the backer material and cutting an edge of the backer material prior to partitioning the elongated roll into discrete rolls.

5. The method of claim 1 further comprising controlling moisture content of the backer material prior to application of the multiple rows of adhesive.

6. The method of claim 1 further comprising coating at least one surface of the backer material with a plastic material prior to application of the multiple rows of adhesive.

7. The method of claim 6 further comprising increasing the surface energy of the at least one surface of the backer material that is coated with the plastic material prior to application of the multiple rows of adhesive.

8. A method of forming a masking tape material comprising:
selecting an adhesive to be elastically deformable and to have a stiffness value that is insufficient to overcome a tack value associated with interaction of the selected adhesive with an intended application surface;
selecting a backer material for supporting the selected adhesive; and
treating at least one side of the backer material with a plastic material prior to placement of the selected adhesive relative thereto.

9. The method of claim 8 wherein selecting the adhesive includes selecting an adhesive that is elastically deformable at least more than 1.25 times an at rest thickness of the selected adhesive.

10. The method of claim 8 wherein selecting the adhesive is further defined as selecting the adhesive from at least one of polyurethane gel adhesives, silicone, gel adhesives, and acrylic gel adhesives.

11. The method of claim 8 wherein the backer material is selected from one of a plastic material, a cloth material, and a paper material.

12. The method of claim 11 further comprising manipulating a surface energy of the plastic material prior to placement of the selected adhesive relative thereto.

13. The method of claim 11 further comprising controlling a moisture content of the backer material prior to the treating the backer material with the plastic material.

14. The method of claim 8 further comprising forming an indicia associated with a lateral position of at least one of multiple lanes of the selected adhesive relative to the hacker material.

15. The method of claim 14 further comprising controlling a position of the backer material relative to a slitting operation based on a position associated with the indicia.

16. A method of forming a masking material, the method comprising:
providing a substrate material;
treating at least one side of the substrate material with a plastic material; and
manipulating a surface energy of the plastic material to achieve a desired adhesion of an adhesive disposed on the at least one side of the substrate material to the substrate material.

17. The method of claim 16 further comprising forming an indicia associated with a lateral position of at least one lane of adhesive disposed on the substrate material.

18. The method of claim 17 further comprising cutting the substrate material into discrete rolls of masking material as a function of a location of the indicia.

19. The method of claim 18 further comprising manipulating a lateral position of the substrate material relative to a cutting device as a function of a position of the indicia.

20. The method of claim 16 further comprising controlling a moisture content of the substrate material prior to treatment of the substrate material with the plastic material.
